(19) United States
(12) Patent Application Publication
(10) Pub. No.: US 2010/0049343 A1
(43) Pub. Date: Feb. 25, 2010

(54) Non-intrusive acoustic monitoring for equipment diagnostic and fault reporting

(75) Inventors: Peeyush Jaiswal, Flower Mound, TX (US); Naveen Narayan, Boca Raton, FL (US)

Correspondence Address: DUKE W. YEE, YEE AND ASSOCIATES, P.C., P.O. BOX 802333, DALLAS, TX, 75380, US

(73) Assignee: International Business Machines Corporation, Armonk, NY (US)

(21) Appl. No.: 12/197,891

(22) Filed: Aug. 25, 2008

(51) Int. Cl. G06F 17/00

(52) U.S. Cl. 700/94

(57) ABSTRACT

A computer implemented method, a computer program product, and a data processing system provide acoustic monitoring and fault reporting. A sound is identified from a consumer device. The sound to an acoustic signal. An acoustic fingerprint is generated from the acoustic signal. The acoustic fingerprint is then compared to a threshold value to determine whether the acoustic fingerprint deviates from a threshold value by more than a defined statistical variance. If the acoustic fingerprint deviates from a threshold value by more than a defined statistical variance, notification is provided that the acoustic fingerprint deviates from the threshold value by more than the defined statistical variance.

### BACKGROUND OF THE INVENTION

1. Field of the Invention

The present application relates generally a computer implemented method, a computer program product, and a data processing system. More specifically the present application relates to a computer implemented method, a computer program product, and a data processing system for non-intrusive acoustic monitoring for equipment diagnostic and fault reporting.

2. Description of the Related Art

Commercially available pre-packaged machinery generally comes with some kind of fault detection and reporting. The electrical circuitry in this pre-packaged machinery may contain break switches and fuses for exception conditions. Probes can be placed as special interface ports to report current voltage and heat dissipation status. Similarly, the pre-packaged machinery may have electrical and mechanical circuitry consisting of fuses and interfaces for process for error detection and reporting.

However, most first chance error detection is typically empirical. A user may notice an anomaly in the system, such as a noise or malfunction. The user may then have the machinery repaired, all without the triggering of any mechanical or electrical fault detection scheme.

The empirically detected issue may or may not be an anomaly. However, whether or not the empirically detected issue is problematic cannot be determined until the user or a specialist examines the issue more closely. This close examination of the machinery may or may not require specialized probes or equipment and adequate knowledge of the machinery.

By way of example, a user may notice an abnormal humming noise when operating the user's automobile. The user may empirically conclude that the brakes of the automobile are not working properly.

In this scenario, the user has made a guess that the brakes are not working. In actuality, a different problem may be present with the automobile. A specialist may have to inspect the automobile further to confirm the guessed diagnosis by the user.

### BRIEF SUMMARY OF THE INVENTION

A computer implemented method, a computer program product, and a data processing system provide acoustic monitoring and fault reporting. A sound is identified from a consumer device. The sound to an acoustic signal. An acoustic fingerprint is generated from the acoustic signal. The acoustic fingerprint is then compared to a threshold value to determine whether the acoustic fingerprint deviates from a threshold value by more than a defined statistical variance. If the acoustic fingerprint deviates from a threshold value by more than a defined statistical variance, notification is provided that the acoustic fingerprint deviates from the threshold value by more than the defined statistical variance.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a data flow between the various software and hardware components according to an illustrative embodiment;

FIG. 4 is a flowchart of a process for acoustic monitoring of a device and fault reporting according to an illustrative process;

FIG. 5 is a flowchart of a process for the acoustic monitoring of a device according to an illustrative embodiment; and

FIG. 6 is a flowchart of a process for monitoring acoustic fingerprints and generating notifications according to an illustrative embodiment.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

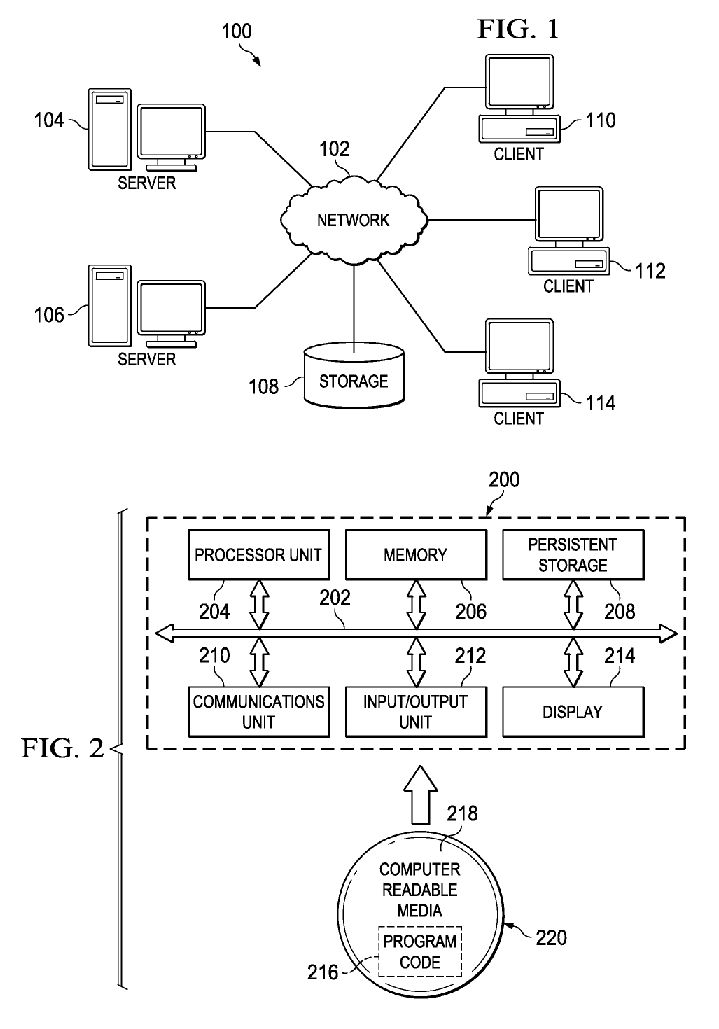

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

The illustrative embodiments described herein provide a non-intrusive acoustic monitoring for equipment diagnostic and fault reporting. The non-intrusive controller may be placed in a piece of machinery to monitor and report on the machine's status. This device can be used to recognize acoustic levels for status monitoring and reporting. The controller monitors acoustic levels of a device and compares them to a sound fingerprint emitted by the device under normal conditions. The monitor can be configured to accept acoustic levels from one or multiple monitored devices

A computer implemented method, a computer program product, and a data processing system provide acoustic monitoring and fault reporting. A sound is identified from a consumer device. The sound to an acoustic signal. An acoustic fingerprint is generated from the acoustic signal. The acoustic fingerprint is then compared to a threshold value to determine whether the acoustic fingerprint deviates from a threshold value by more than a defined statistical variance. If the acoustic fingerprint deviates from a threshold value by more than a defined statistical variance, notification is provided that the acoustic fingerprint deviates from the threshold value by more than the defined statistical variance.

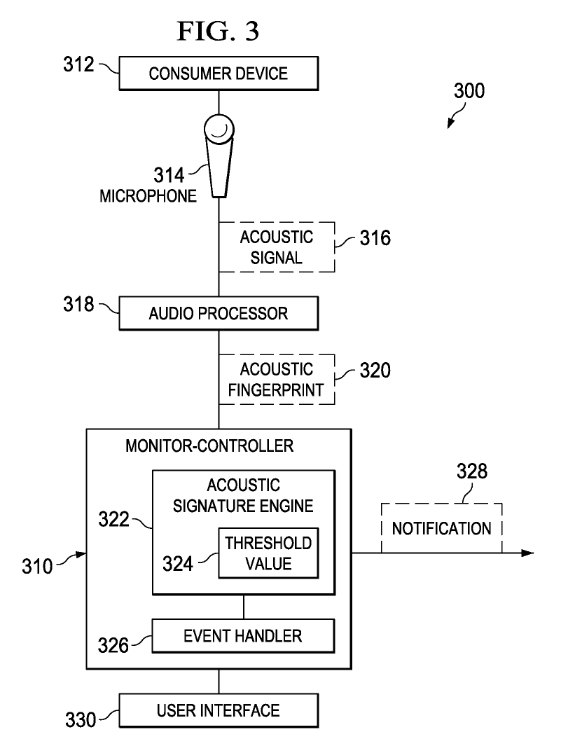

Referring now to FIG. 3, a data flow between the various software and hardware components is shown according to an illustrative embodiment. System 300 includes monitor-controller 310, which is a data processing system, such as data processing system 100 of FIG. 1.

Consumer device 312 can be any device that generates repetitious noise, hereinafter, an acoustic signal. Consumer device 312 can be, without limitation, a consumer household appliance, such as a washing machine, a clothes dryer, a dishwasher, a hot water heater, an air conditioning unit, a heat pump, or any other household device that generates an acoustic signal under normal operation. Consumer device 312 can also be, without limitation, a component or subsystem of a larger device, such as a transmission or brake rotor of an automobile.

Coupled to, or placed in close proximity of consumer device 312 is microphone 314. Microphone 314 detects sounds from consumer device 312. Acoustic signal 316 is the electrical signal produced my microphone 314 in response to detecting sound from consumer device 312.

Audio processor 318 converts acoustic signal 316 into acoustic fingerprint 320. Audio processor 318 can be a hardware based component or software based component. Acoustic signal 316 may undergo a Fourier transformation, or other digital transformation, to create acoustic fingerprint 320. Acoustic fingerprint 320 can be a spectral representation of the acoustic signal 316. Characteristics of the transformed acoustic signal are isolated from the transformed acoustic signal, and compared to known sample statistical models of known subject matter and performers to determine similarities using known methods, such as vector quantization, hidden Markov modeling, and multivariate auto-regression modeling. Alternatively, audio processor 318 can convert acoustic signal 316 using a hash method to obtain acoustic fingerprint 320 as a compact representation of acoustic signal 316.

Acoustic fingerprint 320 is then forwarded to monitor-controller 310. Monitor-controller 310 includes acoustic signature engine 322. Acoustic signature engine 322 is a software component that compares acoustic fingerprint 320 to threshold value 324. Threshold value 324 is an ideal acoustic fingerprint 320 of consumer device 312 for normal operation and operating conditions of consumer device 312. That is, threshold value 324 is the acoustic fingerprint 320 of consumer device 312 during normal operation of consumer device 312.

Threshold value 324 may also include some defined statistical variance from threshold value 324. The defined statistical variance is a deviation by which acoustic fingerprint 320 may differ from threshold value 324 without triggering event handler 326.

Event handler 326 is a software component that notifies a user if acoustic fingerprint 320 deviates from threshold value 324 by more than the defined statistical variance. If the acoustic signature engine 322 determines that acoustic fingerprint 320 has deviated from threshold value 324 by more than the defined statistical variance, acoustic signature engine 322 triggers event handler 326. Event hander 326 provides notification 328 to a user or other person that the acoustic fingerprint 320 is no longer within normal operating parameters defined by the threshold value 324.

Notification 328 can be provided in a number of different ways. For example, notification 328 can be provided an auditory or visual alarm, such as a siren, or a light emitting diode indicator. Notification 328 also can be an email or short messaging service formatted (text message) alert sent to a user at a mobile or desktop data processing system, such as one of clients 110-114 of FIG. 1.

In one preferred embodiment, a user is provided with user interface 330 to access monitor-controller 310. Through user interface 330, a user can adjust the defined statistical variance for threshold value 324. Through user interface 330, a user may also be able to reset to threshold value 324 to correspond to a current acoustic fingerprint 320. User interface 330 may also provide an output for notification 328, such that a user can determine whether acoustic fingerprint 320 deviates from threshold value 324 by more than the defined statistical variance by examining user interface 330.

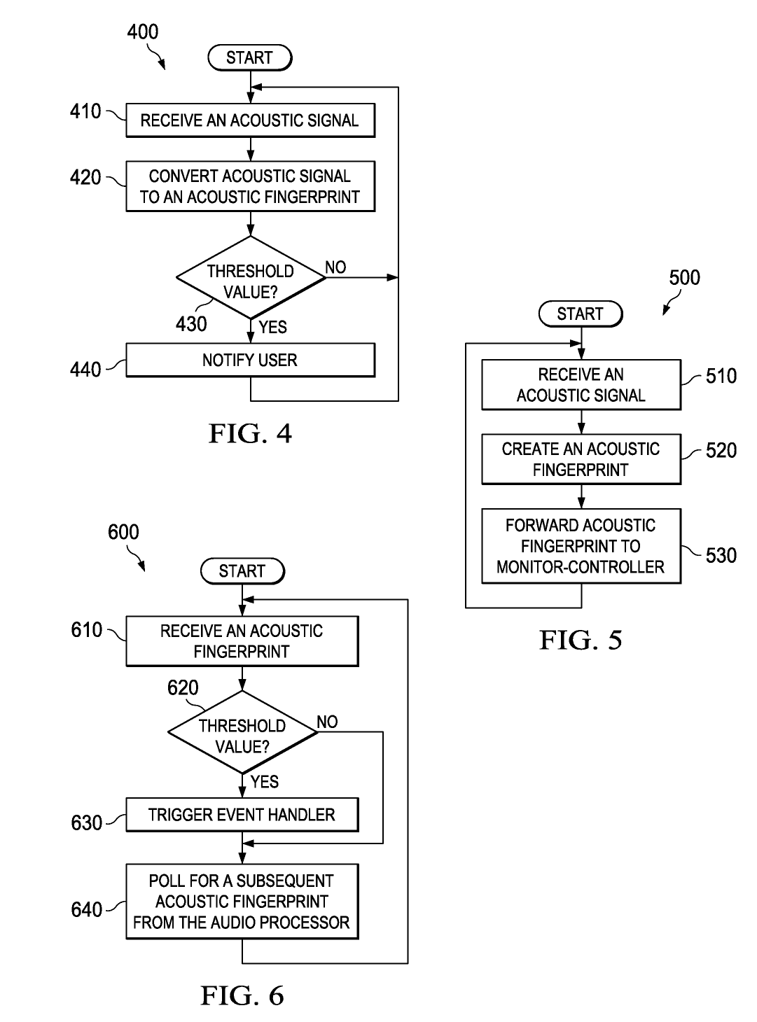

Referring now to FIG. 4, a flowchart of a process for acoustic monitoring of a device and fault reporting is shown according to an illustrative process. Process 400 is executed on the various components of system 300 of FIG. 3.

Process 400 begins by receiving an acoustic signal (step 410). The acoustic signal can be acoustic signal 316 of FIG. 3. Responsive to receiving the acoustic signal, process 400 converts the acoustic signal to an acoustic fingerprint (step 420). The acoustic fingerprint can be acoustic fingerprint 320 of FIG. 3.

Responsive to converting the acoustic signal to an acoustic fingerprint, process 400 compares the acoustic fingerprint to a threshold value to determine whether the acoustic fingerprint deviates from the threshold value by more than a defined statistical variance (step 430). The threshold value can be threshold value 324 of FIG. 3. By comparing the acoustic fingerprint to the threshold value, process 400 determines whether the acoustic fingerprint deviates from the threshold value by more than a defined statistical variance.

Responsive to determining that the acoustic fingerprint deviates from the threshold value by more than a defined statistical variance (“yes” at step 430), process 400 provides a notification to a user or other person the acoustic fingerprint is no longer within normal operating parameters defined by the threshold value (step 440). Process 400 can then return to step 410 in an iterative fashion. Notification can be provided by way of an auditory or visual alarm, such as a siren, or a light emitting diode indicator. Notification can be an email or short messaging service formatted (text message) alert sent to a user at a mobile device, or desktop data processing system.

Responsive to a determination that the the acoustic fingerprint does not deviates from the threshold value by more than a defined statistical variance (“no” at step 430), process 400 returns to step 410 in an iterative fashion.

Referring now to FIG. 5, a flowchart of a process for the acoustic monitoring of a device is shown according to an illustrative embodiment. Process 500 can be a software process, executing on a software component, such as audio processor 318 of FIG. 3.

Process 500 begins by receiving an acoustic signal (step 510). The acoustic signal, which can be acoustic signal 316 of FIG. 3, is the electrical signal produced by a microphone in response to detecting sound from a monitored device, such as consumer device 312 of FIG. 3.

Responsive to receiving the acoustic signal, process 500 creates an acoustic fingerprint (step 520). The acoustic signal may undergo a Fourier transformation, or other digital transformation, to create the acoustic fingerprint. The acoustic fingerprint can be a spectral representation of the acoustic signal. Characteristics of the transformed acoustic signal are isolated from the transformed media signal, and compared to known sample statistical models of known subject matter and performers to determine similarities using known methods, such as vector quantization, hidden Markov modeling, and multivariate auto-regression modeling. Alternatively, the acoustic signal can be converted using a hash method to obtain the acoustic fingerprint as a compact representation of the acoustic signal.

Responsive to converting the acoustic signal into an acoustic fingerprint, process 500 forwards the acoustic fingerprint to a monitor-controller (step 530). Process 500 then returns to step 510 in an iterative manner to poll for, and receive subsequent acoustic signals.

Referring now to FIG. 6, a flowchart of a process for monitoring acoustic fingerprints and generating notifications is shown according to an illustrative embodiment. Process 600 is a software process executing or a software component, such as acoustic signature engine 322 of FIG. 3.

Process 600 begins by receiving an acoustic fingerprint (step 610). The acoustic fingerprint can be acoustic fingerprint 320 of FIG. 3. The acoustic fingerprint can be a spectral representation of the acoustic signal. Characteristics of the transformed acoustic signal are isolated from the transformed media signal, and compared to known sample statistical models of known subject matter and performers to determine similarities using known methods. These methods, may include, for example, vector quantization, hidden Markov modeling, and multivariate auto-regression modeling. Alternatively, the acoustic signal can be converted using a hash method to obtain the acoustic fingerprint as a compact representation of the acoustic signal. The acoustic fingerprint is received from an audio processor, such as audio processor 318 of FIG. 3.

Process 600 then determines whether the acoustic fingerprint deviates from a threshold value by more than a defined statistical variance (step 620). The threshold value is an ideal acoustic fingerprint of the monitored device during normal operation and operating conditions. That is, threshold value is the acoustic fingerprint of the monitored device during normal operation of the monitored device. The threshold value can be threshold value 324 of FIG. 3. The defined statistical variance is a deviation by which an acoustic fingerprint may differ from the threshold value without triggering event handler.

Responsive to determining that the acoustic fingerprint deviates from a threshold value by more than the defined statistical variance (“yes” at step 620), process 600 triggers an event handler (step 630). The event handler, which can be event handler 326 of FIG. 3, is a software component that notifies a user that the acoustic fingerprint has deviated from the threshold value by more than the defined statistical variance. That is, the event handler provides notification to a user or other person that the acoustic fingerprint is no longer within normal operating parameters defined by the threshold value.

Responsive to triggering the event handler, process 600 polls for a subsequent acoustic fingerprint from the audio processor (step 640). Process 600 then returns to step 610 in an iterative manner when a subsequent acoustic fingerprint is received.

Retuning now to step 620, responsive to not determining that the acoustic fingerprint deviates from a threshold value by more than the defined statistical variance (“no” at step 620), process 600 polls for a subsequent acoustic fingerprint from the audio processor (step 640). Process 600 then returns to step 610 in an iterative manner when a subsequent acoustic fingerprint is received.

Thus, the illustrative embodiments described herein provide a non-intrusive acoustic monitoring for equipment diagnostic and fault reporting. The non-intrusive controller may be placed in a piece of machinery to monitor and report on the machine's status. This device can be used to recognize acoustic levels for status monitoring and reporting. The controller monitors acoustic levels of a device and compares them to a sound fingerprint emitted by the device under normal conditions. The monitor can be configured to accept acoustic levels from one or multiple monitored devices.

A computer implemented method, a computer program product, and a data processing system provide acoustic monitoring and fault reporting. A sound is identified from a consumer device. The sound to an acoustic signal. An acoustic fingerprint is generated from the acoustic signal. The acoustic fingerprint is then compared to a threshold value to determine whether the acoustic fingerprint deviates from a threshold value by more than a defined statistical variance. If the acoustic fingerprint deviates from a threshold value by more than a defined statistical variance, notification is provided that the acoustic fingerprint deviates from the threshold value by more than the defined statistical variance.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for acoustic monitoring and fault reporting, the method comprising:
identifying a sound from a consumer device;
responsive to identifying the sound from a consumer device, converting the sound to an acoustic signal;
responsive to identifying the acoustic signal, generating an acoustic fingerprint from the acoustic signal;
responsive to generating the acoustic fingerprint from the acoustic signal, identifying whether the acoustic fingerprint deviates from a threshold value by more than a defined statistical variance; and
responsive to identifying that the acoustic fingerprint deviates from a threshold value by more than a defined statistical variance, providing notification that the acoustic fingerprint deviates from the threshold value by more than the defined statistical variance.

2. The computer implemented method of claim 1, wherein the step of identifying a sound from a consumer device further comprises:
identifying a sound with a microphone proximately placed to the consumer device.

3. The computer implemented method of claim 1, wherein the step of generating an acoustic fingerprint from the acoustic signal further comprises:
generating an acoustic fingerprint by digitally transforming the acoustic signal by a Fourier transformation, wherein the acoustic fingerprint is a spectral representation of the acoustic signal.

4. The computer implemented method of claim 1, wherein the step of generating an acoustic fingerprint from the acoustic signal further comprises:
generating an acoustic fingerprint from the acoustic signal using a hash method to obtain the acoustic fingerprint as a compact representation of the acoustic signal.

5. The computer implemented method of claim 1, wherein the step of identifying whether the acoustic fingerprint deviates from a threshold value by more than a defined statistical variance further comprises:
identifying whether the acoustic fingerprint deviates from a threshold value by more than a defined statistical variance, wherein the threshold value is an ideal acoustic fingerprint of the consumer device during normal operating conditions.

6. The computer implemented method of claim 1, the method further comprising:
responsive to identifying that the acoustic fingerprint deviates from a threshold value by more than a defined statistical variance, triggering an event handler, wherein the event handler provides notification that the acoustic fingerprint deviates from the threshold value by more than the defined statistical variance.

7. The computer implemented method of claim 6, wherein the event handler provides notification by triggering an auditory alarm, triggering a visual alarm, sending an email, or sending a short messaging service formatted alert.

8. A computer program product for acoustic monitoring and fault reporting, the computer program product comprising:
A computer usable medium having computer usable program code embodied therewith, the computer usable program code comprising:
computer usable program code to identify a sound from a consumer device;
computer usable program code, responsive to identifying the sound from a consumer device, to convert the sound to an acoustic signal;
computer usable program code, responsive to identifying the acoustic signal, to generate an acoustic fingerprint from the acoustic signal;
computer usable program code, responsive to generating the acoustic fingerprint from the acoustic signal, to identify whether the acoustic fingerprint deviates from a threshold value by more than a defined statistical variance; and
computer usable program code, responsive to identifying that the acoustic fingerprint deviates from a threshold value by more than a defined statistical variance, to provide notification that the acoustic fingerprint deviates from the threshold value by more than the defined statistical variance.

9. The computer program product of claim 8, wherein the step of identifying a sound from a consumer device further comprises:
computer usable program code to identify a sound with a microphone proximately placed to the consumer device.

10. The computer program product of claim 8, wherein the step of generating an acoustic fingerprint from the acoustic signal further comprises:
computer usable program code to generate an acoustic fingerprint by digitally transforming the acoustic signal by a Fourier transformation, wherein the acoustic fingerprint is a spectral representation of the acoustic signal.

11. The computer program product of claim 8, wherein the step of generating an acoustic fingerprint from the acoustic signal further comprises:
computer usable program code to generate an acoustic fingerprint from the acoustic signal using a hash method to obtain the acoustic fingerprint as a compact representation of the acoustic signal.

12. The computer program product of claim 8, wherein the step of identifying whether the acoustic fingerprint deviates from a threshold value by more than a defined statistical variance further comprises:
computer usable program code to identify whether the acoustic fingerprint deviates from a threshold value by more than a defined statistical variance, wherein the threshold value is an ideal acoustic fingerprint of the consumer device during normal operating conditions.

13. The computer program product of claim 8, the method further comprising:
computer usable program code, responsive to identifying that the acoustic fingerprint deviates from a threshold value by more than a defined statistical variance, to trigger an event handler, wherein the event handler provides notification that the acoustic fingerprint deviates from the threshold value by more than the defined statistical variance.

14. The computer program product of claim 13, wherein the computer usable program to trigger an event handler is for providing notification by triggering an auditory alarm, triggering a visual alarm, sending an email, or sending a short messaging service formatted alert.

15. A data processing system for acoustic monitoring and fault reporting, the data processing system comprising:
a bus;
a storage device connected to the bus, wherein the storage device contains a computer usable code; and
a processing unit connected to the bus, wherein the processing unit executes the computer usable program code to identifying a sound from a consumer device; responsive to identifying the sound from a consumer device, to convert the sound to an acoustic signal; responsive to identifying the acoustic signal, to generate an acoustic fingerprint from the acoustic signal; responsive to generating the acoustic fingerprint from the acoustic signal, to identify whether the acoustic fingerprint deviates from a threshold value by more than a defined statistical variance; and responsive to identifying that the acoustic fingerprint deviates from a threshold value by more than a defined statistical variance, to provide notification that the acoustic fingerprint deviates from the threshold value by more than the defined statistical variance.

16. The data processing system of claim 15, wherein the processing unit executing the computer usable program code to identify a sound from a consumer device further comprises:
the processing unit executing the computer usable program code to identify a sound with a microphone proximately placed to the consumer device.

17. The data processing system of claim 15, wherein the processing unit executing the computer usable program code to generating an acoustic fingerprint from the acoustic signal further comprises:
the processing unit executing the computer usable program code to generate an acoustic fingerprint by digitally transforming the acoustic signal by a Fourier transformation, wherein the acoustic fingerprint is a spectral representation of the acoustic signal.

18. The data processing system of claim 15, wherein the processing unit executes the computer usable program code to generate an acoustic fingerprint from the acoustic signal further comprises:
the processing unit executing the computer usable program code to generate an acoustic fingerprint from the acoustic signal using a hash method to obtain the acoustic fingerprint as a compact representation of the acoustic signal.

19. The data processing system of claim 15, wherein the processing unit executes the computer usable program code to identify whether the acoustic fingerprint deviates from a threshold value by more than a defined statistical variance further comprises:
the processing unit executing the computer usable program code to identify whether the acoustic fingerprint deviates from a threshold value by more than a defined statistical variance, wherein the threshold value is an ideal acoustic fingerprint of the consumer device during normal operating conditions.

20. The data processing system of claim 15, wherein the processing unit further executes the computer usable program code, responsive to identifying that the acoustic fingerprint deviates from a threshold value by more than a defined statistical variance, to trigger an event handler, wherein the event handler provides notification that the acoustic fingerprint deviates from the threshold value by more than the defined statistical variance.

21. The data processing system of claim 20, wherein the event handler provides notification by triggering an auditory alarm, triggering a visual alarm, sending an email, or sending a short messaging service formatted alert.
